(19) United States
(12) Patent Application Publication
(10) Pub. No.: US 2007/0210076 A1
(43) Pub. Date: Sep. 13, 2007

(54) Low frequency heating device and article made therefrom

(76) Inventors: Stephen B. Fitch, Massillon, OH (US); Daniel T. Corney, North Canton, OH (US); William Stuehr, North Royalton, OH (US); John E. Gadus, Brunswick, OH (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/365,314

(22) Filed: Mar. 1, 2006

(51) Int. Cl. H05B 6/10

(52) U.S. Cl. 219/640

(57) ABSTRACT

A low frequency heating device comprises for heating a machine component comprising a low frequency power supply connected to a coil, a housing having an interior for placement of a machine component, the coil being wound around the housing. A machine component is formed by heating with a low frequency heating device with the device comprising a low frequency power supply connected to a coil, a housing having an interior for placement of the machine component therein, and the coil being wound around the housing.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention relates in general to a device for producing a machine component and, more particularly, to a low frequency heating device for producing a machine component.

Low carbon steel has good ductility and as such will withstand bending stresses and impacts. However, low carbon steel cannot be hardened to the extent required for wear resistant surfaces. High carbon steel, on the other hand, in view of its high carbon content, will transform into a large proportion of martensite when subjected to a proper heat treatment. Martensite is the hardest structure that can be obtained from steel in any appreciable amount. A properly hardened high carbon steel resists fatigue, wear, indentation, and abrasion. Further hardened high carbon steel provides a good wear surface. However, high carbon hardened steels are somewhat brittle and not as tough as low carbon steels. Case-carburizing enables ductile low carbon steel to acquire a hard surface or case which resists fatigue, wear, indentations, and abrasion. Case-carburized steel possesses the attributes and qualities of both low carbon steel in the core region and properly treated high carbon steel in the case region.

Iron at elevated temperatures on the order of 1350° F. to 1850° F. exhibits an affinity for carbon. A workpiece formed from low carbon steel is heated in a carbon-rich atmosphere and the carbon diffuses into the steel. The extent of the diffusion depends on the constituency of the carbon-rich atmosphere, which is often carbon monoxide and methane, the temperature to which the steel is heated, and the time it remains in the carbon-rich atmosphere. In effect, the region at the surface of the steel workpiece transforms into high carbon steel. Thus, when the workpiece is heated above the temperature at which the carbon-enriched portion becomes austenite, and then quenched, the carbon-enriched portion to a large measure transforms into martensite and becomes a hard case, but the remaining portion, called the core, remains relatively soft and ductile.

An important application of case-carburizing resides in the manufacture of rolling element bearings, i.e., tapered cylindrical, spherical, needle, or ball bearings. Such bearings typically have two races, each provided with a raceway, and rolling elements that are positioned between the races and roll along the raceways when one of the races rotates relative to the other race. The races of these bearings must withstand impact stresses and thus should have the ductility of low or medium carbon steel. However, the surfaces of the races, particularly the surfaces that the rolling elements contact, should be hard to resist wear, indentations and abrasion. Case-carburizing further imparts residual compressive stresses to the cases of the ring-shaped races and this enables the races, along their raceways to better withstand bending fatigue and to inhibit the propagation of cracks from nicks. Carburizing raceways will distort the race requiring a press quench operation. This is accomplished by heating the races in a rotary furnace to an austenitic temperature and transferring the component to a press quench. The races are individually quenched and restricted in distortion by range or part specific tooling. This process produces races with near finished dimensions and microstructures suitable for long bearing life. However, this method is time consuming and requires the use of a furnace. It would be advantageous and desirable to provide a device for producing a machine component that does not require a rotary furnace. In certain applications, races composed of thru-hardened grade of steel may be acceptable. The higher carbon content of these grades requires a hardening process consisting of the races being heated in a furnace for a specific amount of time prior to quenching. Quenching is accomplished in a press quench using part specific or range type tooling to minimize the distortion. After hardening, the races will have near finished dimensions with microstructures suitable for long bearing life. It is also desirable to provide a device for heating a machine component to produce a machine component that has microstructural uniformity that is similar to that produced by a rotary furnace. A machine component may be comprised of case-carburized steel or thru-hardened steel.

### SUMMARY OF THE INVENTION

The present invention resides in a low frequency heating device that uses an induction coil to through heat a machine component such as a race of an antifriction bearing. The present invention also resides in an article made by the low frequency heating device.

### BRIEF DESCRIPTION OF THE DRAWINGS

FIG. 1 is a block diagram of a low frequency heating device constructed according to the present invention;

FIG. 2 is a perspective view of the low frequency heating device constructed according to the present invention;

FIG. 3 is a top view of a pair of the low frequency heating device shown in FIG. 2;

FIG. 4 is a cross sectional view of a race that may be heated by the low frequency heating device of the present invention;

FIG. 5 is a photograph of the microstructure of a retaining rib of a race that has been heated by the low frequency heating device of the present invention;

FIG. 6 is a photograph of the microstructure of a raceway of a race that has been heated by the low frequency heating device of the present invention;

FIG. 7 is a photograph of the microstructure of a rib face of a race that has been heated by the low frequency heating device of the present invention;

FIG. 8 is a photograph of the microstructure of a thrust rib of a race that has been heated by the low frequency heating device of the present invention;

FIG. 9 is a photograph of the microstructure of a bore of a cone that has been heated by the low frequency heating device of the present invention;

FIG. 10 is a photograph of the microstructure of a core of a race that has been heated by the low frequency heating device of the present invention;

FIG. 11 is a photograph of the microstructure of a corner of a thrust rib of a race that has been heated by the low frequency heating device of the present invention;

FIG. 12 is a photograph of the microstructure of a raceway of a race that has been heated by the use of a rotary furnace;

FIG. 13 is a photograph of the microstructure of a thrust rib of a race that has been heated by the use of a rotary furnace; and

FIG. 14 is a photograph of the microstructure of a corner of a thrust rib of a race that has been heated by the use of a rotary furnace.

### DETAILED DESCRIPTION OF THE PREFERRED EMBODIMENTS

Referring now to the drawings and in particular to FIG. 1, a low frequency heating device 10 constructed according to the present invention is shown. The low frequency heating device 10 comprises a low frequency power supply 12 having a pair of leads 14 and 16 connected to a coil 18, such as an induction coil. The low frequency power supply 12 may be in the range of 1 to 3 kHz and may be capable of providing 200 kW of power. The coil 18 is wound around a housing 20 such as a spool type body. The coil 18 may consists of copper wire or tubing that is wound around the housing 20. Although not shown, a component such as a race of a roller bearing may be placed within the housing 20. Once the power supply 12 is operated to energize the coil 18, the cone is heated to a desired temperature within a specific period of time relative to the power supplied from power supply 12 to the coil 18. By way of example only, the coil 18 may be energized at 76 kW for 90 seconds. Also, the power supply 12 is capable of varying power as needed.

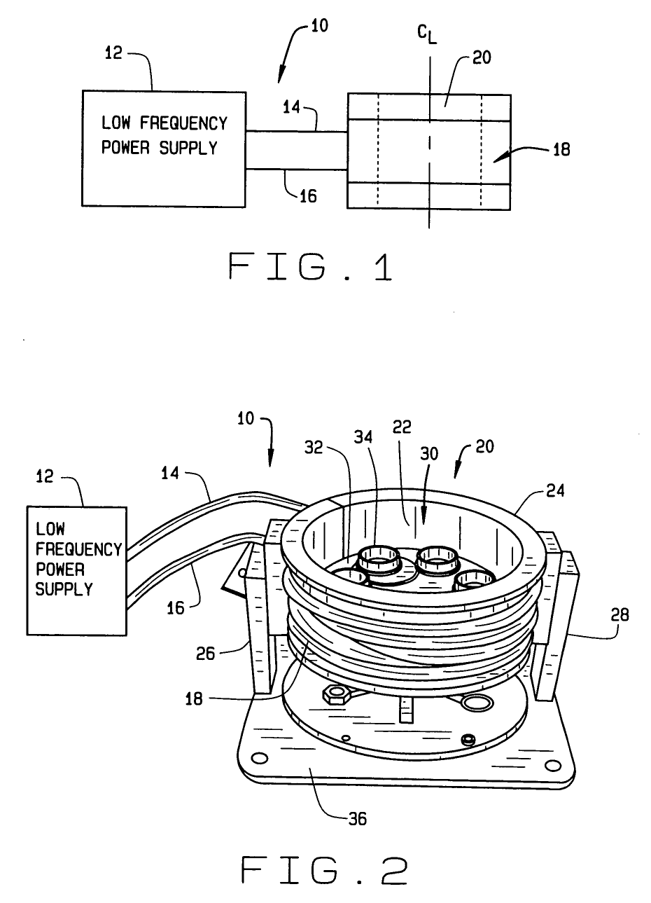

With reference now to FIG. 2, a perspective view of the low frequency heating device 10 is illustrated. The low frequency heating device 10 has the low frequency power supply 12 connected to the coil 18 via the leads 14 and 16. The coil 18 may comprise water-cooled copper tubing that is capable of being wound around the housing 20 in a number of turns of the coil 18. The coil 18 may be insulated at various positions, as will be discussed further herein. The housing 20 has several spool type bodies 22 having several flanges 24. The spool type bodies 22 may be fastened together at the flanges 24 and held in an upright position by use of a pair of mounting brackets 26 and 28. The housing 20 has an interior 30 having a floor surface 32 upon which may be placed one or more machine components 34, such as races for roller bearings. The brackets 26 and 28 may be fastened to a table 36.

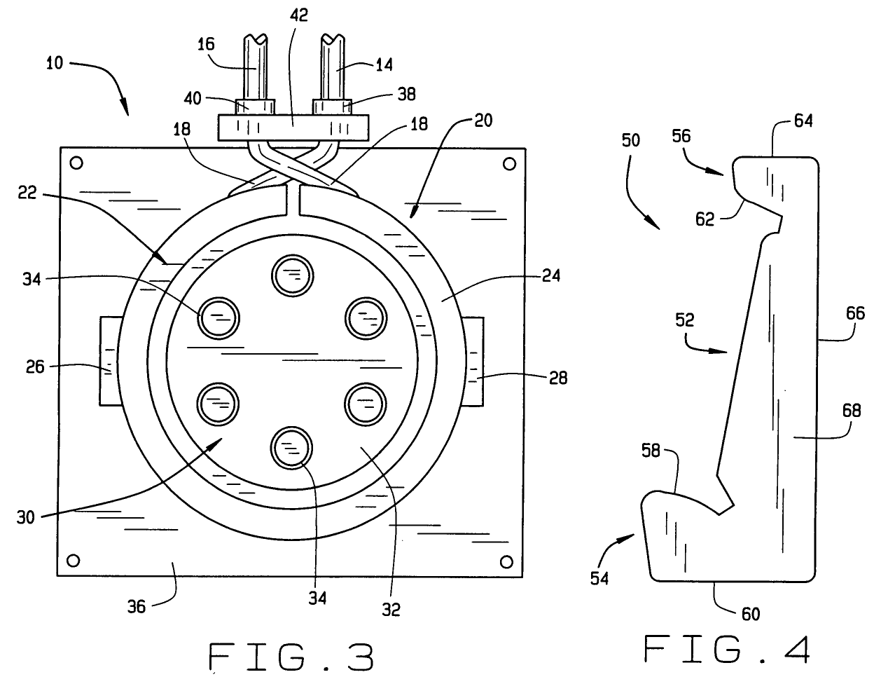

FIG. 3 depicts a top view of the low frequency heating device 10. The housing 20 has the coil 18 wrapped around the housing 20. The leads 14 and 16 may be connected to contacts 38 and 40, respectively. The leads 14 and 16 are not shown being connected to the low frequency power supply 12 in this illustration. The housing 20 may be assembled by stacking several 3/16 inch thick to ¼ inch thick copper spools 22 rolled to a specific inside diameter to form the housing 20. The coil 18 may be wound around the stack formation of the spools 22 and may be fastened at one point to the housing 20. A specific size and length of copper tubing may be wrapped around the housing 20 and attached to the leads 14 and 16. The initial turn of the coil 18 may be mechanically fastened to the housing 20. From this point the copper tubing may also be insulated with Teflon tubing. The end of the tubing may be cut to fit and be fastened to the contacts 38 and 40 that are held in place with an insulated bracket 42. Although not shown, the housing 20 may also have exterior cooling jackets having independent inlet and outlet cooling connections. Each cooling jacket may be sandwiched between the flanges 24 of the spool body 22 to remove as much heat as possible. The cooling jackets may be constructed of copper tubing tabs that fasten to the housing 20.

The housing 20 is shown to have the spool type body 22 having the upper flange 24. The body 22 of the housing 20 may be held in an upright position by use of the pair of mounting brackets 26 and 28. The housing 20 has the interior 30 having the floor surface 32 upon which may be placed the machine components 34. The components 34 must be placed at positions greater than one inch from the interior 30. The brackets 26 and 28 must be placed on the table 36. The brackets 26 and 28 and the table 36 may be constructed of insulating material, or non-martensitic material, or paramagnetic material.

With reference now to FIG. 4, a cross-sectional view of a machine component such as a cone 50 that may be heated by the low frequency heating device 10 of the present invention is illustrated. The cone 50 has a tapered raceway 52 as well as a thrust rib 54 and a retaining rib 56 that project outwardly beyond the raceway 52. The thrust rib 54 has a rib face 58 and a back face 60. The retaining rib 56 has a rib face 62 and a front face 64. The cone 50 also has a bore 66 and a core 68. The cone 50 is an example of a machine component that may be heated by the low frequency heating device 10.

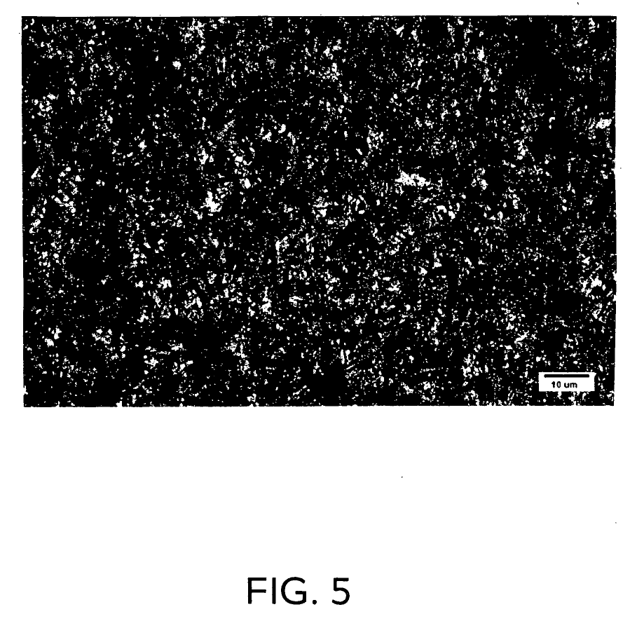

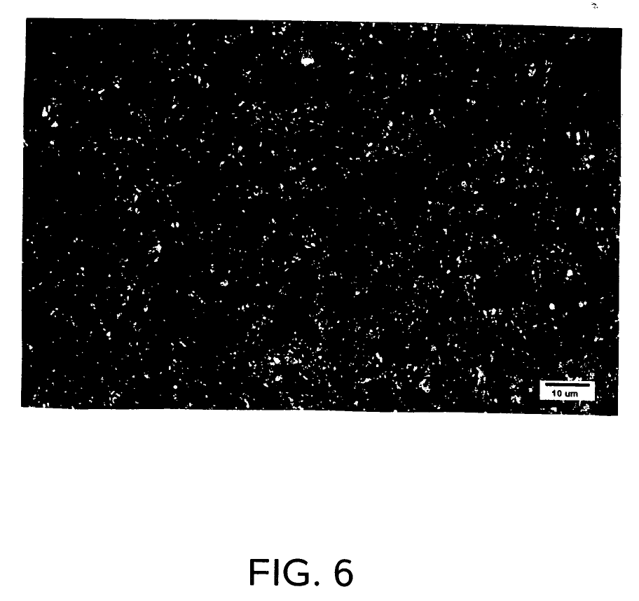

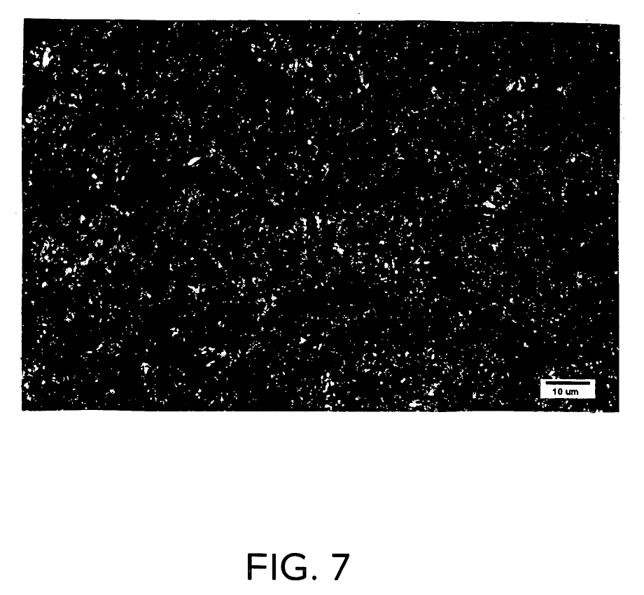

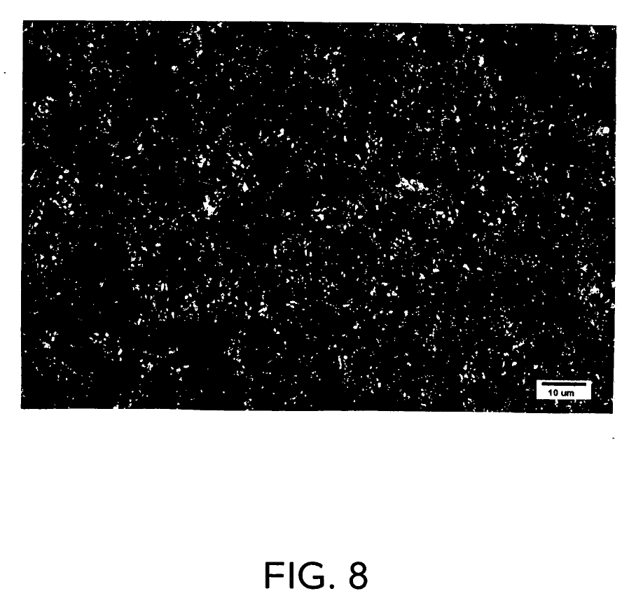

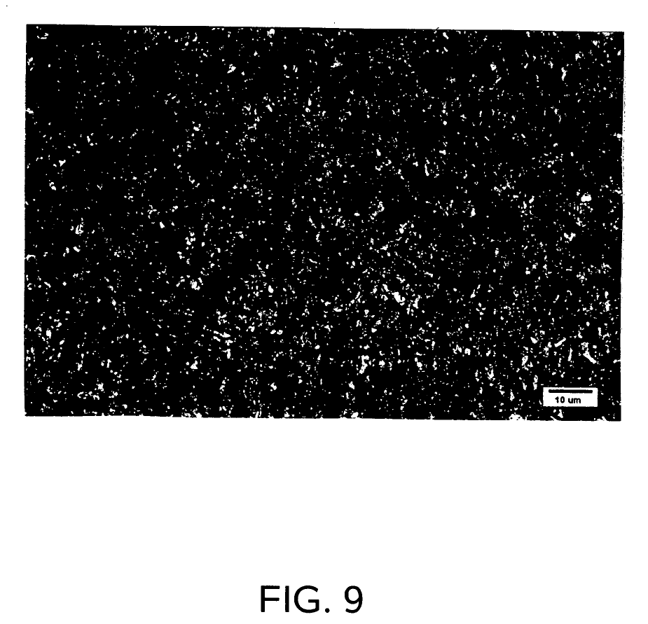

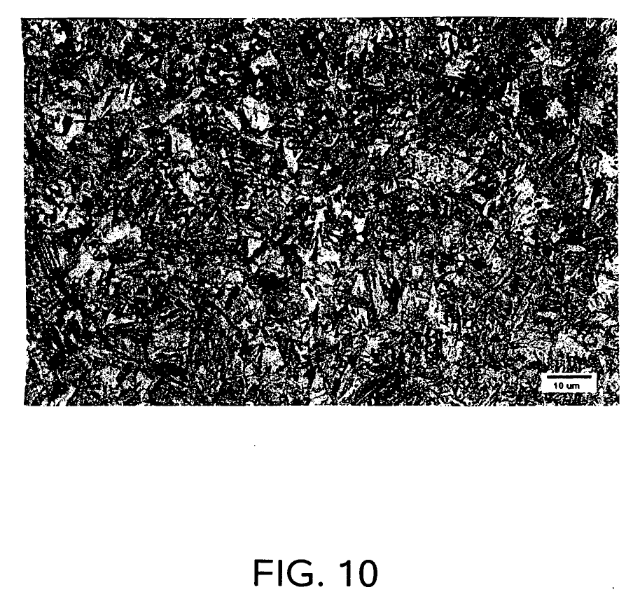

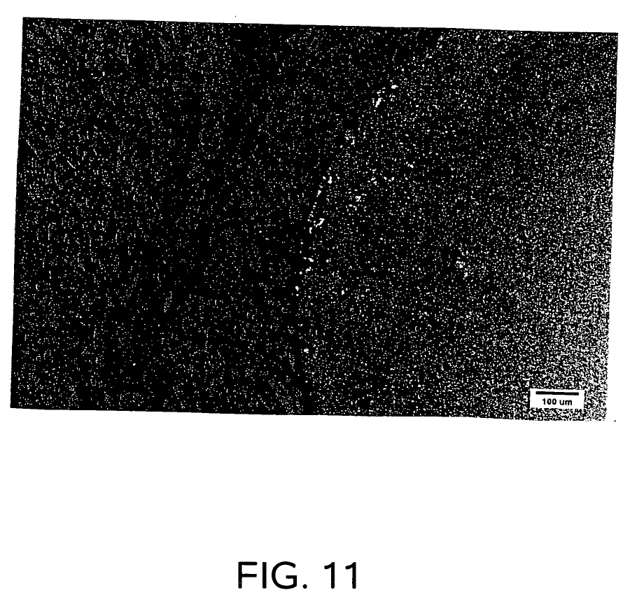

FIGS. 5-11 are photographs of the microstructure of the cone 50 at various positions on the cone 50 after the cone 50 has been subjected to heating by the low frequency heating device 10. In particular, FIG. 5 shows the microstructure of the retaining rib 56, FIG. 6 shows the microstructure of the raceway 52, FIG. 7 shows the microstructure of the rib face 58, FIG. 8 shows the microstructure of the thrust rib 54, FIG. 9 shows the microstructure of the bore 66, FIG. 10 shows the microstructure of the core 68, and FIG. 11 shows the microstructure of a corner of the thrust rib 54 at low magnification. The case microstructure consisted of fine, tempered martensite with retained austenite and few carbides. The core microstructure consisted of tempered martensite and contained less than 5% ferrite.

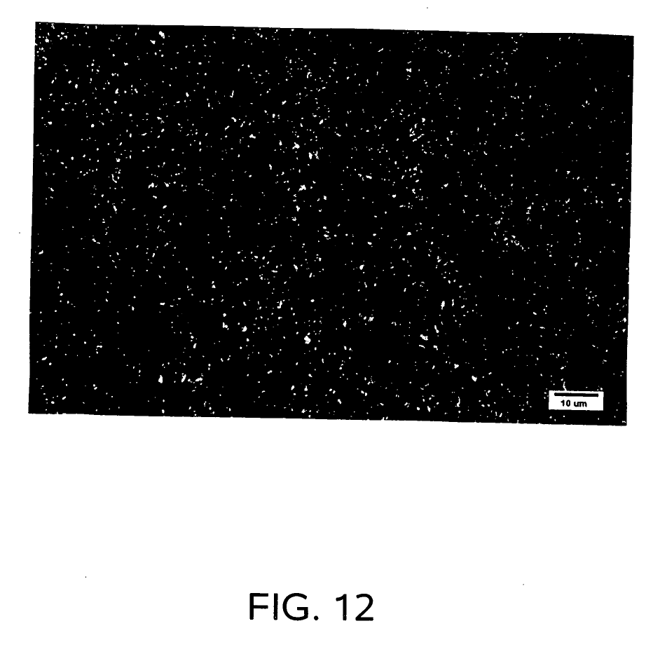

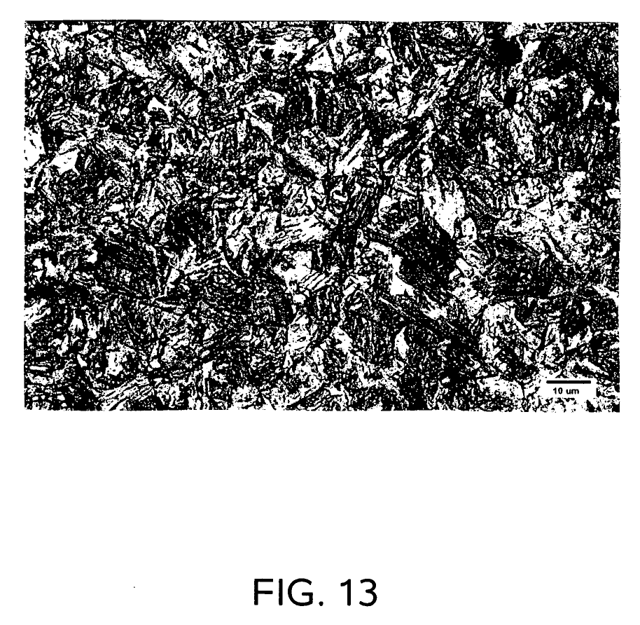

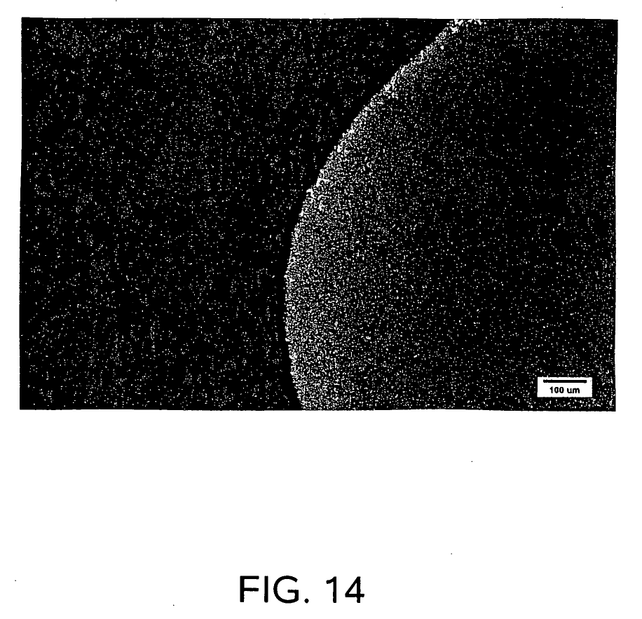

FIGS. 12-14 are photographs of the microstructure of another cone 50 at various positions on the cone 50 after the cone 50 has been subjected to heating by a rotary furnace. For example, FIG. 12 shows the microstructure of the raceway 52, FIG. 13 shows the microstructure of the thrust rib 54, and FIG. 14 shows the microstructure of a corner of the thrust rib 54 at low magnification. The case microstructure of the raceway in FIG. 12 consists of tempered martensite and retained austenite. The corner of the thrust rib in FIG. 14 contains some carbides. A comparison of FIGS. 6 and 12, FIGS. 8 and 13, and FIGS. 11 and 14 shows little difference between the microstructures of a low frequency heating hardened cone and a furnace hardened cone.

The low frequency heating device 10 was tested in the following manner to determine if cones heated by use of the device 10 have acceptable amounts of retained austenite in the case and <5% ferrite in the core. Eighteen as-carburized JRM55049 cones were used in the test. Three batches consisting of six cones each were heated during testing. Due to material handling, only three cones were quenched from each batch. The quenchant used was agitated Quench Oil 103 (fast quench oil) at room temperature. The total power for each batch was recorded and appears in Table 1. All samples were furnace tempered at 360° F. for 1.3 hours. The nine cones that were quenched were submitted to magnetic particle inspection. No cracks were found in any of the cones.

TABLE 1
Total Power per Batch

| Batch | Total Power (kWhr) |
|---|---|
| 001 | 0.93 |
| 002 | 0.93 |
| 003 | 0.93 |

Retained austenite was visually rated for the small rib or retaining rib 56, the raceway 52, the large rib face 58, and the large rib outside diameter 54. These results are shown in Table 2. Also shown in Table 2 are the average values of three furnace hardened and tempered JRM55049 cones. A comparison of the retained austenite values in Table 2 shows that some of the low frequency hardened cones have less retained austenite in the small rib than the furnace hardened cones. The cones have a uniform case microstructure and the cones were heated uniformly regardless of the position of the cone within the device 10.

TABLE 2
Visual Retained Austenite

| | | % Retained Austenite | | | |
|---|---|---|---|---|---|
| | | Small Rib | | Large Rib | Large Rib |
| Batch | Sample | O.D. | Race | Face | O.D. |
| 001 | A | 10-15 | 10-15 | 10-15 | 5-10 |
| | C | 10-15 | 10-15 | 10-15 | 10-15 |
| | E | 10-15 | 10-15 | 10-15 | 5-10 |
| 002 | B | 5-10 | 15-20 | 15-20 | 15-20 |
| | D | 10-15 | 15-20 | 15-20 | 10-15 |
| | F | 5-10 | 10-15 | 15-20 | 15-20 |
| 003 | A-0° | 5-10 | 10-15 | 20-25 | 15-20 |
| | A-120° | 5-10 | 10-15 | 10-15 | 5-10 |
| | A-240° | 10-15 | 15-20 | 10-15 | 10-15 |
| 003 | C-0° | 10-15 | 15-20 | 20-25 | 15-20 |
| | C-120° | 5-10 | 15-20 | 15-20 | 15-20 |
| | C-240° | 5-10 | 10-15 | 15-20 | 10-15 |
| 003 | E-0° | 5-10 | 10-15 | 15-20 | 15-20 |
| | E-120° | 5-10 | 10-15 | 15-20 | 10-15 |
| | E-240° | 15-20 | 15-20 | 15-20 | 15-20 |
| Furnace | n/a | 15-20 | 15-20 | 20-25 | 15-20 |

Case hardness was measured using the MT-90 at 0.020 inches depth from the surface at various locations. These results are shown in Table 3. The results for the average values of three furnace hardened and tempered JRM55049 cones are also indicated in Table 3 for comparison with the low frequency heated cones.

TABLE 3
Case Hardness at 0.020″ Depth

| | | Hardness, HRc | | | |
|---|---|---|---|---|---|
| | | Small Rib | | Large Rib | Large Rib |
| Batch | Sample | O.D. | Race | Face | O.D. |
| 001 | A | 63.0 | 63.2 | 63.9 | 63.4 |
| | C | 63.2 | 63.2 | 64.0 | 63.5 |
| | E | 63.8 | 62.9 | 63.9 | 63.4 |
| 002 | B | 62.9 | 62.4 | 63.6 | 63.1 |
| | D | 63.2 | 63.0 | 63.8 | 63.8 |
| | F | 62.9 | 62.2 | 63.7 | 62.8 |
| 003 | A-0° | 63.4 | 63.1 | 63.5 | 63.4 |
| | A-120° | 63.5 | 63.1 | 63.4 | 63.5 |
| | A-240° | 63.7 | 63.0 | 63.7 | 63.8 |
| 003 | C-0° | 63.1 | 62.9 | 63.7 | 63.3 |
| | C-120° | 63.4 | 63.1 | 64.1 | 63.5 |
| | C-240° | 63.7 | 63.0 | 63.5 | 63.7 |
| 003 | E-0° | 62.9 | 62.8 | 63.1 | 62.7 |
| | E-120° | 62.8 | 63.0 | 63.4 | 63.3 |
| | E-240° | 63.5 | 63.2 | 63.5 | 63.7 |
| Furnace | n/a | 62.9 | 62.9 | 63.8 | 63.7 |

Core hardness was measured near the small rib, the center of the sectioned component, and the large rib of the cones. These measurements are shown in Table 4. Table 4 has the results of the average values of three furnace hardened and tempered cones.

TABLE 4
Core Hardness

| | | Core Hardness, HRc | | |
|---|---|---|---|---|
| Batch | Sample | Small Rib | A-section | Large Rib |
| 001 | A | 43.9 | 44.9 | 42.9 |
| | C | 43.5 | 44.4 | 42.9 |
| | E | 41.8 | 43.5 | 43.8 |
| 002 | B | 44.0 | 43.0 | 43.3 |
| | D | 44.2 | 43.4 | 41.7 |
| | F | 43.1 | 44.4 | 43.5 |
| 003 | A-0° | 44.1 | 43.5 | 41.5 |
| | A-120° | 44.8 | 44.0 | 42.5 |
| | A-240° | 44.5 | 45.3 | 43.5 |
| 003 | C-0° | 44.9 | 44.6 | 45.0 |
| | C-120° | 45.7 | 45.1 | 44.8 |
| | C-240° | 45.0 | 45.0 | 44.6 |
| 003 | E-0° | 43.2 | 44.0 | 44.7 |
| | E-120° | 41.0 | 44.0 | 43.9 |
| | E-240° | 42.3 | 44.6 | 44.6 |
| Furnace | n/a | 45.2 | 44.1 | 44.7 |

Multiple cones may be heated by use of the device 10 to produce case and core microstructures similar to cones that were furnace hardened. Retained austenite was found to be about 15% and the core ferrite was found to be less than 5%. Case and core hardness were indistinguishable between the furnace hardened cones and the cones produced by the use of the low frequency heating device 10. Further, no overheating was observed in the low frequency heating hardened cones. Overall cycle time for each batch of low frequency heating hardened cones was 90 seconds. The energy requirements for the coil 18 is low being less than 1 kWh and the power required is 37 kW, which is only 18.5% of the 200 kW power supply.

Other machine components, other than bearings, that can be manufactured by the device 10 of the present invention include gears, traction drives, and cams. Such machine components are subjected to loading and stresses that are conductive to spallings and fatigue failure.

Other heating applications such as tempering and annealing are possible with use of the low frequency heating device 10.

It will be appreciated that aspects of the embodiments of the present invention may be combined in various combinations to generate other alternative embodiments while staying within the scope of the present invention.

From all that has been said, it will be clear that there has thus been shown and described herein a low frequency heating device which fulfills the various objects and advantages sought therefore. It will become apparent to those skilled in the art, however, that many changes, modifications, variations, and other uses and applications of the subject low frequency heating device are possible and contemplated. All changes, modifications, variations, and other uses and applications which do not depart from the spirit and scope of the invention are deemed to be covered by the invention, which is limited only by the claims which follow.

What is claimed is:

1. A low frequency heating device for heating a machine component comprising a low frequency power supply connected to a coil, a housing having an interior for placement of a machine component, the coil being wound around the housing.

2. The low frequency heating device of claim 1 wherein the low frequency power supply is in the range of 1 to 3 kHz.

3. The low frequency heating device of claim 1 wherein the low frequency power supply is capable of varying power as needed.

4. The low frequency heating device of claim 1 wherein the machine component is tempered by the low frequency heating device.

5. The low frequency heating device of claim 1 wherein the coil comprises copper tubing.

6. The low frequency heating device of claim 1 wherein the housing has a spool type body for wrapping the coil around.

7. The low frequency heating device of claim 1 wherein the low frequency power supply is connected to the coil via a pair of leads.

8. The low frequency heating device of claim 1 wherein the interior of the housing is large enough to have placed therein more than one machine component.

9. The low frequency heating device of claim 1 wherein the machine component is annealed by the low frequency heating device.

10. A low frequency heating device for heating a machine component comprising:
a low frequency power supply;
an induction coil, the induction coil being connected to the power supply; and
a housing having a spool type body, the induction coil being wound around the body, the body having an interior within which may be positioned a machine component to be heated.

11. The low frequency heating device of claim 10 wherein the low frequency power supply is in the range of 1 to 3 kHz.

12. The low frequency heating device of claim 10 wherein the low frequency power supply is capable of varying power as needed.

13. The low frequency heating device of claim 10 wherein the machine component is tempered by the low frequency heating device.

14. The low frequency heating device of claim 10 wherein the coil is insulated.

15. The low frequency heating device of claim 10 wherein the coil comprises copper tubing.

16. The low frequency heating device of claim 10 wherein the interior of the body is large enough to have positioned therein more than one machine component.

17. The low frequency heating device of claim 10 wherein the machine component is annealed by the low frequency heating device.

18. A method of heating a machine component comprising the steps of positioning a machine component within a housing and energizing a coil wound around the housing through the use of a low frequency power supply.

19. The method of claim 18 further providing the step of energizing the coil for a period of time relative to the power supplied by the power supply.

20. The method of claim 18 wherein the low frequency power supply has a frequency range of 1 to 3 kHz.

21. The method of claim 18 further comprising the steps of insulating the coil.

22. The method of claim 18 further comprising the step of cooling the coil and the housing.

23. A machine component formed by heating with a low frequency heating device comprising a low frequency power supply connected to a coil, a housing having an interior for placement of the machine component therein, and the coil being wound around the housing.
